(19) United States
(12) Patent Application Publication
(10) Pub. No.: US 2014/0318822 A1
(43) Pub. Date: Oct. 30, 2014

(54) Portable Power Tool

(71) Applicant: Robert Bosch GmbH, Stuttgart (DE)

(72) Inventors: Andre Ullrich, Leinfelden-Echterdingen (DE); Holger Froehling, Stuttgart (DE)

(73) Assignee: Robert Bosch GmbH, Stuttgart (DE)

(21) Appl. No.: 14/254,989

(22) Filed: Apr. 17, 2014

(30) Foreign Application Priority Data
Apr. 26, 2013 (DE) 10 2013 207 689.4

(51) Int. Cl. B25F 5/02

(52) U.S. Cl. CPC B25F 5/02
USPC 173/170

(57) ABSTRACT

A portable power tool includes at least one tool receptacle (60) which has at least one rotation axis, and includes at least one housing which has at least one handle region. The handle region comprises at least one gripping plane extending at least substantially parallel to the rotation axis of the tool receptacle. The gripping plane extends through a point on the housing that is located on a side of the housing that is remote from the tool receptacle. The point is a point on the housing that is closest to the tool receptacle on that side of the housing that is remote from the tool receptacle. The gripping plane is at a minimum distance of greater than 4 mm from the rotation axis.

This application claims priority under 35 U.S.C. §119 to patent application no. DE 10 2013 207 689.4, filed on Apr. 26, 2013 in Germany, the disclosure of which is incorporated herein by reference in its entirety.

### BACKGROUND

Portable power tools which comprise a tool receptacle which has a rotation axis, and a housing which has a handle region that comprises a gripping plane extending parallel to the rotation axis of the tool receptacle, said gripping plane extending through a point on the housing that is arranged on a side of the housing that is remote from the tool receptacle, said point being closest to the tool receptacle on that side of the housing that is remote from the tool receptacle, are already known.

### SUMMARY

The disclosure proceeds from a portable power tool having at least one tool receptacle which has at least one rotation axis, and having at least one housing which has at least one handle region that comprises at least one gripping plane extending at least substantially parallel to the rotation axis of the tool receptacle, said gripping plane extending through a point on the housing that is arranged on a side of the housing that is remote from the tool receptacle, said point being closest to the tool receptacle on that side of the housing that is remote from the tool receptacle.

It is proposed that the gripping plane is at a minimum distance of greater than 4 mm from the rotation axis of the tool receptacle. In particular, the gripping plane is at a minimum distance of greater than 6 mm, preferably greater than 8 mm and particularly preferably greater than 10 mm, from the rotation axis of the tool receptacle. In this case, the minimum distance preferably has a value of between 4 mm and 16 mm. The point through which the gripping plane extends is arranged preferably in a parting plane of housing shells of the housing. Preferably, the point through which the gripping plane extends forms an extreme point of a profile of a gripping recess of the handle region. In this case, the point through which the gripping plane extends is preferably the deepest point of the gripping recess, viewed in a plane extending at least substantially perpendicularly to the gripping plane, or viewed in the parting plane of housing shells of the housing. Particularly preferably, the gripping plane is arranged on a side of a plane which is remote from a handle stem of the handle region, wherein the plane includes the rotation axis of the tool receptacle. Thus, the gripping plane is arranged above the rotation axis of the tool receptacle when viewed in a direction which extends from a battery receptacle region of the handle stem to the rotation axis of the tool receptacle.

A “portable power tool” should be understood here as meaning in particular a power tool for machining workpieces, which can be transported by an operator without the use of a transport machine and can be held or operated by an operator with at least one hand while machining the workpiece. The portable power tool has in particular a mass of less than 40 kg, preferably less than 10 kg and particularly preferably less than 5 kg. The portable power tool is configured preferably as a drywall screwdriver, as a drilling machine, as a percussion drilling machine or as a rotary and/or demolition hammer. A “drywall screwdriver” should be understood in this context as meaning in particular a portable power tool which is intended to machine in particular materials such as plasterboard, for example, and preferably to screw screws into materials such as plasterboard, for example. The term “intended” should be understood as meaning in particular specially configured, designed and/or equipped. However, it is also conceivable for the portable power tool to have some other configuration that appears appropriate to a person skilled in the art. The rotation axis of the tool receptacle extends preferably coaxially with the rotation axis of a drive unit of the portable power tool. The drive unit is configured particularly preferably as a brushless DC motor (EC motor). However, it is also conceivable for the drive unit to be configured as a DC motor. The drive unit is arranged or mounted in a motor housing region of the housing. The rotation axis of the drive unit is formed preferably by a rotation axis of a drive shaft, in particular of an armature shaft, of the drive unit.

The expression “handle region” is intended here to define in particular a region of the housing on which an operator places a palm of a hand when the portable power tool is handled properly, or at which an operator at least partially grasps the housing when the portable power tool is handled properly. The handle region of the housing is formed integrally with the motor housing region of the housing. In this case, the housing can have a shell-like and/or cup-like structure already known to a person skilled in the art. The term “integrally” should be understood as meaning in particular at least cohesively connected, for example by a welding process, an adhesive-bonding process, an injection process and/or some other process that appears appropriate to a person skilled in the art, and/or be understood as meaning advantageously formed in one piece, for example by being produced from a casting and/or by being produced in a single-component or multi-component injection-molding process, and advantageously from a single blank. Particularly preferably, the housing is formed in a pistol-like manner. The expression “gripping plane” is intended here to define in particular a plane of the handle region in which a supporting line of the handle region for an index finger and a thumb of a hand of an operator extends when the portable power tool is handled properly. The expression “at least substantially” should be understood in this context as meaning in particular that a deviation from a specified value and/or from a specified geometric relationship, in particular an angular relationship or length relationship, is in particular less than 20%, preferably less than 10% and particularly preferably less than 5%. By means of the configuration according to the disclosure, an ergonomically formed handle region can advantageously be realized, in particular in the case of a configuration of the portable power tool with a drive unit in the form of an EC motor. Thus, high operating comfort for an operator when handling the portable power tool can advantageously be achieved.

Furthermore, it is proposed that the handle region comprises at least one gripping recess that has at least one point of intersection in common with the gripping plane, said gripping recess having a radius of greater than 7 mm. Preferably, the gripping recess is formed in a concave manner. Particularly preferably, the handle region has at least one gripping recess that has at least one point of intersection in common with the gripping plane, said gripping recess having a radius of greater than 7 mm, when viewed in a cross section extending at least substantially perpendicularly to the gripping plane. In particular, the gripping recess has a radius of greater than 8 mm, preferably greater than 9 mm and particularly preferably greater than 10 mm. In this case, the radius preferably has a value of between 7 mm and 11 mm. Particularly preferably, the common point of intersection is formed by that point on the housing that is arranged on that side of the housing that is remote from the tool receptacle, said point being closest to the tool receptacle on that side of the housing that is remote from the tool receptacle. By means of the configuration according to the disclosure of the gripping recess, an ergonomic bearing surface for an index finger and a thumb of a hand of an operator can advantageously be realized.

It is furthermore proposed that the handle region comprises a minimum gripping width, extending in the gripping plane, of less than 60 mm. A “gripping width” should be understood here as meaning in particular a minimum distance between two gripping recesses or gripping recess regions that are arranged on housing sides that face away from one another. In particular, the gripping recess has a minimum gripping width of less than 55 mm, preferably less than 50 mm and particularly preferably less than 48 mm. In this case, the minimum gripping width preferably has a value of between 40 mm and 60 mm. By means of the configuration according to the disclosure of the gripping width, comfortable gripping of the housing in the gripping plane can advantageously be enabled. Premature fatigue of a hand of an operator can advantageously be counteracted.

In addition, it is proposed that the portable power tool comprises at least one operator control unit which has at least one operator control element, wherein a minimum gripping circumference of the handle region, said minimum gripping circumference extending via the operator control element and at least partially through a gripping recess of the handle region, is less than 180 mm. An “operator control unit” should be understood here as meaning in particular a unit which has at least one component, in particular the operator control element, which is actuable directly by an operator and is intended, by actuation and/or by input of parameters, to influence and/or alter a process and/or a state of a unit coupled to the operator control unit. Preferably, the operator control unit is intended to control and/or regulate a power flow to the drive unit. Preferably, the minimum gripping circumference is measured with the operator control element actuated or pressed. In particular, the handle region has a minimum gripping circumference of less than 175 mm, preferably less than 170 mm and particularly preferably less than mm. In this case, the minimum gripping circumference preferably has a value of between 140 mm and 180 mm. By means of the configuration according to the disclosure of the minimum gripping circumference, comfortable grasping of the handle stem of the handle region can advantageously be enabled when an index finger and a thumb of a hand of an operator are arranged. In addition, ergonomic actuation of the operator control element can advantageously be enabled.

Furthermore, it is proposed that the portable power tool comprises at least the operator control unit which has at least the operator control element which is at a minimum distance of less than 60 mm from the gripping recess of the handle region. In particular, the operator control element is at a minimum distance of less than 58 mm, preferably less than 55 mm and particularly preferably less than 53 mm from the gripping recess. In this case, the minimum distance of the operator control element from the gripping recess preferably has a value of between 35 mm and 65 mm. By means of the configuration according to the disclosure of the minimum distance of the operator control element from the gripping recess, low-fatigue holding of the operator control element in an operated state can advantageously be enabled.

Furthermore, it is proposed that a longitudinal axis of the handle stem and the rotation axis of the tool receptacle enclose a gripping angle of greater than 60°. In particular, the longitudinal axis of the handle stem and the rotation axis of the tool receptacle enclose a gripping angle of greater than 65°, preferably greater than 70° and particularly preferably greater than 75°. In this case, the gripping angle enclosed by the longitudinal axis of the handle stem and by the rotation axis of the tool receptacle preferably has a value of between 90° and 125°. By means of the configuration according to the disclosure of the gripping angle, comfortable holding, in particular ergonomic holding, of the portable power tool can advantageously be achieved.

In addition, it is proposed that at least one gripping recess of the handle region has a gripping plane radius of greater than 20 mm when viewed in the gripping plane. In particular, the gripping recess has a gripping plane radius of greater than 22 mm, preferably greater than 24 mm and particularly preferably greater than 26 mm when viewed in the gripping plane. In this case, the gripping recess preferably comprises a gripping plane radius which has a value of between 20 mm and 28 mm when viewed in the gripping plane. By means of the configuration according to the disclosure of the radius, comfortable supporting of an index finger and a thumb of a hand of an operator while handling the portable power tool can advantageously be enabled, this allowing ergonomic holding.

Furthermore, it is proposed that the housing has a maximum motor housing region width, extending in a plane that includes the rotation axis of the tool receptacle, of less than 65 mm. The plane including the rotation axis of the tool receptacle extends at least substantially parallel to the gripping plane. In particular, the housing has a maximum motor housing region width of less than 60 mm, preferably less than 58 mm and particularly preferably less than 55 mm. In this case, the maximum motor housing region width preferably has a value of between 45 mm and 70 mm. By means of the configuration according to the disclosure of the maximum motor housing region width, a compact housing can advantageously be realized which particularly advantageously allows an ergonomic configuration.

Furthermore, it is proposed that the housing has a minimum projection of greater than 2 mm relative to a point, located in the gripping plane, on the gripping recess of the handle region. In particular, the housing has a minimum projection of greater than 2.5 mm, preferably greater than 3 mm and particularly preferably greater than 4 mm with respect to a point, located in the gripping plane, of the gripping recess. In this case, the minimum projection preferably has a value of between 1.8 mm and 5.5 mm. By means of the configuration according to the disclosure, a narrow housing can advantageously be achieved. In addition, a large finger support surface for fingers of an operator when handling the portable power tool can advantageously be achieved.

In addition, it is proposed that the gripping recess of the handle region has a U-shaped profile when viewed in the gripping plane. Thus, a two-sided arrangement of gripping recess regions of the gripping region can advantageously be achieved. In addition, a large bearing surface for a part of a hand of an operator can advantageously be achieved in order to allow an ergonomic configuration of the housing.

The portable power tool according to the disclosure is not intended to be limited here to the above-described application and embodiment. In particular, the portable power tool according to the disclosure can have a number of individual elements, components and units that differs from the number mentioned herein in order to fulfill a mode of operation described herein.

### BRIEF DESCRIPTION OF THE DRAWINGS

Further advantages can be gathered from the following description of the drawing. The drawing illustrates an exemplary embodiment of the disclosure. The drawing, the description, and the claims contain numerous features in combination. A person skilled in the art will also expediently consider the features individually and combine them to form appropriate further combinations.

In the drawings:

FIG. 1 shows a schematic illustration of a side view of a portable power tool according to the disclosure,

FIG. 2 shows a schematic illustration of a partial sectional view along a gripping plane of a handle region of a housing of the portable power tool according to the disclosure,

FIG. 3 shows a schematic illustration of a rear view of the portable power tool according to the disclosure, and

FIG. 4 shows a schematic illustration of a sectional view through the housing of the portable power tool according to the disclosure.

### DETAILED DESCRIPTION

FIG. 1 shows a side view of a portable power tool 10, wherein a power supply device 50 connected to the portable power tool 10 is illustrated in partial section. The power supply device 50 is in this case in the form of a battery pack which is intended to supply the portable power tool 10 with electrical power. The portable power tool 10 is in the form of a drywall screwdriver. Furthermore, the portable power tool 10 comprises at least one tool receptacle 60 which has at least one rotation axis 14, and at least one housing 16 which has at least one handle region 18 that comprises at least one gripping plane 20 extending at least substantially parallel to the rotation axis 14 of the tool receptacle 60, said gripping plane 20 extending through a point on the housing 16 that is arranged on a side of the housing 16 that is remote from the tool receptacle 60, said point being closest to the tool receptacle 60. In this case, the point on the housing 16 through which the gripping plane 20 extends is at the smallest distance from the tool receptacle 60 compared with other points points arranged on that side of the housing 16 that is remote from the tool receptacle 60. The gripping plane 20 is at a minimum distance 22 of greater than 4 mm from the rotation axis 14 of the tool receptacle 60. In this case, the minimum distance 22 from the rotation axis 14 of the tool receptacle 60 has a value of between 5 mm and 15 mm. For an ergonomic configuration of the housing 16, the minimum distance 22 has a value of between 9 mm and 10 mm.

The gripping plane 20 extends at least substantially perpendicularly to a direction component 52 of a main direction of extension 54 of a handle stem 40 of the handle region 18 of the housing 16. The direction component 52 extends at least substantially parallel to a vertical axis 62 of the portable power tool 10. The vertical axis 62 extends at least substantially perpendicularly to the rotation axis 14 of the tool receptacle 60. Thus, the gripping plane 20 extends at least substantially perpendicularly to the vertical axis 62. The vertical axis 62 extends in a direction which extends from a battery receptacle region 64 of the housing 16, in particular of the handle stem 40, to the rotation axis 14 of the tool receptacle 60. The housing 16 has in this case the form of a pistol housing. The handle stem 40 extends, in a manner already known to a person skilled in the art, in a direction away from the drive unit 12. A longitudinal axis 38 of the handle stem 40 of the handle region 18 and the rotation axis 14 tool receptacle 60 in this case enclose a gripping angle 42 of greater than 60°. In this case, the gripping angle 42 has a value of between 65° and 85°. For an ergonomic configuration of the housing 16, the gripping angle 42 has a value of between 75° and 80°. The gripping angle 42 in this case extends from a side, facing a tool receptacle 60, of the handle stem 40 in the direction of a housing outer surface of the housing 16, said outer surface facing the battery receptacle region 64 of the housing 16, in particular of the handle stem 40.

The handle region 18 is formed integrally with a motor housing region of the housing 16, in which a drive unit 12 and an output unit 56 of the portable power tool 10 are arranged or mounted. The drive unit 12 is in the form of an EC motor. An EC motor requires little installation space, since it is formed in a manner decoupled from carbon brushes. The output unit 56 is in the form of a planetary transmission unit. In this case, the tool receptacle 60 of the portable power tool 10 is driven, in particular driven in rotation, via the output unit 56 by means of a driveshaft 58. The rotation axis 14 of the tool receptacle 60 extends in this case coaxially with a rotation axis of the drive unit 12. However, it is also conceivable for the rotation axis 14 of the tool receptacle 60 to extend in an offset manner, for example offset in a parallel manner with respect to the rotation axis of the drive unit 12. In addition, it is also conceivable for the portable power tool 10 to be formed in a manner decoupled from the output unit 56 and for the driveshaft 58 of the drive unit 12 to directly drive the tool receptacle 60 of the portable power tool 10. In addition, it is conceivable for the output unit 56 to comprise a torque-limiting unit (not illustrated in more detail here) in order to set a tightening torque or a screw-in torque.

Furthermore, the handle region 18 comprises at least one gripping recess 24 that has at least one point of intersection in common with the gripping plane 20, said gripping recess 24 having a radius 26 of less than 15 mm. In this case, the radius 26 has a value of between 8 mm and 14 mm. For an ergonomic configuration of the gripping recess 24, the radius 26 has a value of between 9 mm and 11 mm. The radius 26 is in this case viewed in a plane extending at least substantially perpendicularly to the gripping plane 20.

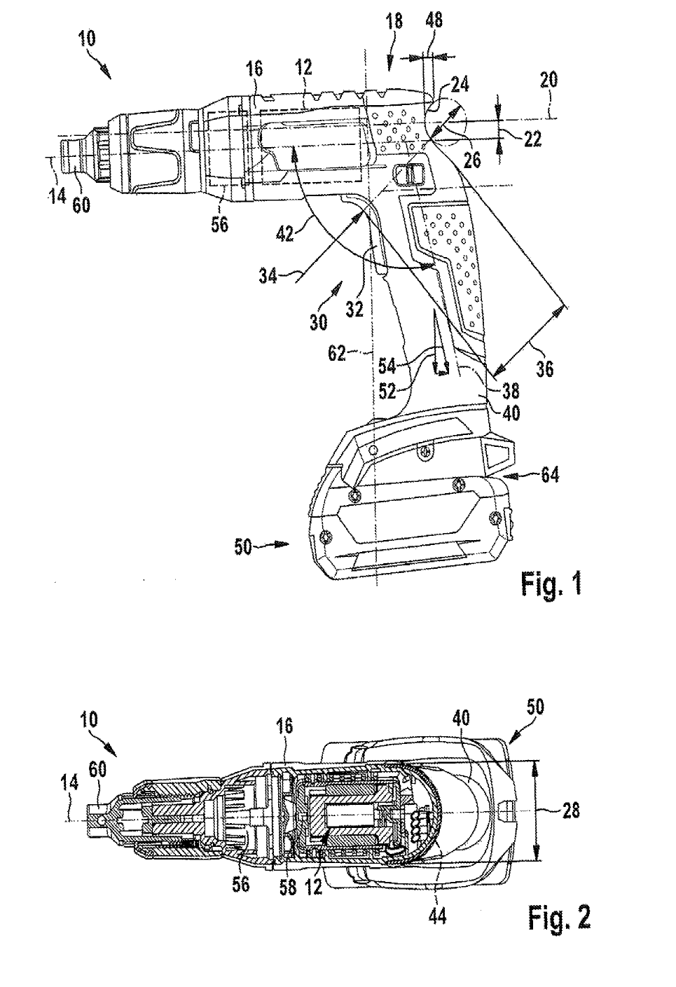

Furthermore, the handle region 18 comprises a minimum gripping width 28, extending in the gripping plane 20, of less than 60 mm (FIG. 2). In this case, the minimum gripping width 28 has a value of between 45 mm and 55 mm. For an ergonomic configuration of the housing 16 in the region of the gripping plane 20, the minimum gripping width 28 has a value of between 48 mm and 52 mm. The minimum gripping width 28 is in this case formed, when viewed in the gripping plane 20, by a minimum distance between two housing outer surfaces of the housing 16 that face away from one another.

The at least one gripping recess 24 of the handle region 18 additionally has a gripping plane radius 44 of greater than 20 mm when viewed in the gripping plane 20 (FIG. 2). In this case, the gripping plane radius 44 has a value of between 20 mm and 30 mm. For an ergonomic configuration of the housing 16 in the region of the gripping plane 20, the gripping plane radius 44 has a value of between 22.5 mm and 27.5 mm. The gripping plane radius 44 is in this case formed by a gripping line, extending in the gripping plane 20, of the gripping recess 24, wherein the gripping line extends on an outer surface of the housing 16. The gripping recess 24 of the handle region 18 thus has a U-shaped profile when viewed in the gripping plane 20.

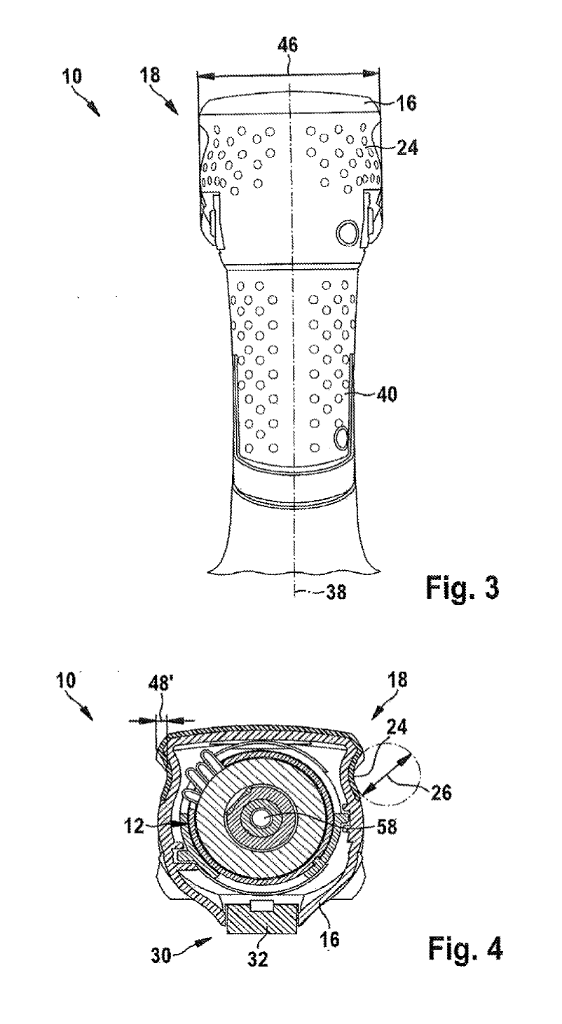

The housing 16 has a minimum projection 48, 48′ of greater than 2 mm relative to a point, located in the gripping plane 20, on the gripping recess 24 of the handle region 18 (FIGS. 1 and 4). In this case, the minimum projection 48, 48′ has a value of between 2 mm and 8 mm. For an ergonomic configuration of the housing 16 in the region of the gripping plane 20, the minimum projection 48, 48′ has a value of between 2.4 mm and 7 mm. The minimum projection 48, 48′ is formed in this case by a distance, extending in the gripping plane 20, between the point, located in the gripping plane 20, on the gripping recess 24 and a plane that extends at least substantially perpendicularly to the gripping plane 20 and intersects the housing 16 at an outermost point located at a distance of at most 10 mm from the gripping plane 20.

If outer walls of the housing 16 that extend at least in part at least substantially parallel to the rotation axis 14 of the tool receptacle 60 are considered, the housing 16 has a minimum projection 48′ which has a value of between 2 mm and 3 mm. On a side of the housing 16 that is remote from the tool receptacle 60, the housing 16 has a minimum projection 48 which has a value of between 2 mm and 7 mm.

Furthermore, the portable power tool 10 comprises at least one operator control unit 30 which has at least one operator control element 32, wherein a minimum gripping circumference 34 of the handle region 18, said minimum gripping circumference extending via the operator control element 32 and at least partially through a gripping recess 24 of the handle region 18, is less than 180 mm. The minimum gripping circumference 34 of the handle region 18 extends in this case in a plane that extends at least substantially transversely to the rotation axis 14 of the tool receptacle 60 and at least substantially transversely to the longitudinal axis 38 of the handle stem 40. In this case, the minimum gripping circumference 34 has a value of between 150 mm and 180 mm. For ergonomic actuation of the operator control element 32, the minimum gripping circumference 34 has a value of between 160 mm and 170 mm. The minimum gripping circumference 34 is measured with the operator control element 32 actuated or pressed.

The at least one operator control unit 30 has at least the operator control element 32 which, when viewed in the gripping plane 20, is at a minimum distance 36 of less than 60 mm from the gripping recess 24 of the handle region 18. In this case, the operator control element 32 is at a minimum distance 36 that has a value of between 45 mm and 60 mm from the gripping recess 24. For ergonomic actuation of the operator control element 32, the operator control element 32 is at a minimum distance 36 that has a value of between 48 mm and 58 mm from the gripping recess 24.

Furthermore, the housing 16 has a maximum motor housing region width 46, extending in a plane that includes the rotation axis 14 of the tool receptacle 60, of less than 65 mm. In this case, the motor housing region width 46 has a value of between 50 mm and 65 mm. For an ergonomic configuration of the housing 16, the motor housing region width 46 has a value of between 50 mm and 60 mm. The plane including the rotation axis 14 of the tool receptacle 60 extends at least substantially parallel to the gripping plane 20. By means of the abovementioned dimensions of the housing 16 and the abovementioned distances of housing parts relative to one another, an ergonomic portable power tool 10 can be realized.

What is claimed is:

1. A portable power tool, comprising:
at least one tool receptacle that includes at least one rotation axis; and
at least one housing that includes at least one handle region having at least one gripping plane extending at least substantially parallel to the at least one rotation axis:
wherein the at least one gripping plane extends through a point on the at least one housing that is located on a side of the at least one housing that is remote from the at least one tool receptacle, such that the point is at a location on side of the at least one housing remote from the at least one tool receptacle that is closest to the at least one tool receptacle; and
wherein the at least one gripping plane is at a minimum distance of greater than 4 mm from the at least one rotation axis.

2. The portable power tool according to claim 1, wherein:
the at least one handle region comprises at least one gripping recess that has at least one point of intersection in common with the at least one gripping plane; and
the at least one gripping recess has a radius of greater than 7 mm.

3. The portable power tool according to claim 1, wherein the at least one handle region has a minimum gripping width, extending in the gripping plane, of less than 60 mm.

4. The portable power tool according to claim 1, further comprising at least one operator control unit that includes at least one operator control element:
wherein the at least one handle region has a minimum gripping circumference extending via the operator control element and at least partially through a gripping recess of the at least one handle region; and
wherein the gripping circumference is less than 180 mm.

5. The portable power tool according to claim 1, further comprising at least one operator control unit that includes at least one operator control element which is at a minimum distance of less than 60 mm from a gripping recess of the at least one handle region.

6. The portable power tool according to claim 1, wherein a longitudinal axis of a handle stem of the at least one handle region and the at least one rotational axis enclose a gripping angle of greater than 60 degrees.

7. The portable power tool according to claim 1, wherein at least one gripping recess of the handle region has a gripping plane radius of greater than 20 mm in a perspective of the at least one gripping plane.

8. The portable power tool according to claim 1, wherein:
the at least one housing has a maximum motor housing region width extending in a plane that includes the at least one rotation axis; and
the maximum motor housing region width is less than 65 mm.

9. The portable power tool according to claim 1, wherein:
the at least one housing includes a minimum projection of greater than 2 mm relative to a point on a gripping recess of the at least one handle region; and
the point is located in the at least one gripping plane.

10. The portable power tool according to claim 1, wherein a gripping recess of the at least one handle region is defined by a U-shaped profile in a perspective of the at least one gripping plane.
